(19) United States
(12) Patent Application Publication
(10) Pub. No.: US 2023/0382381 A1
(43) Pub. Date: Nov. 30, 2023

(54) FOLLOW-UP TRAVEL SUPPORT DEVICE AND FOLLOW-UP TRAVEL SUPPORT METHOD

(71) Applicant: TOYOTA JIDOSHA KABUSHIKI KAISHA, Toyota-shi (JP)

(72) Inventors: Hayato SHIRAI, Tagata-gun (JP); Takashi NISHIKIORI, Numazu-shi (JP); Sui KURIHASHI, Sunto-gun (JP); Takahiro MATSUNAGA, Mishima-shi (JP)

(73) Assignee: TOYOTA JIDOSHA KABUSHIKI KAISHA, Toyota-shi (JP)

(21) Appl. No.: 18/190,942

(22) Filed: Mar. 27, 2023

(30) Foreign Application Priority Data
May 25, 2022 (JP) 2022-085463

(51) Int. Cl. B60W 30/165; H04W 4/46

(52) U.S. Cl. CPC B60W 30/165; H04W 4/46; B60W 2554/4041; B60W 2420/42; B60W 2556/65

(57) ABSTRACT

The follow-up travel support device includes a communication unit capable of communicating with a plurality of vehicles; a storage unit storing a list of follow-up permitted vehicles permitting being a follow-up target of another vehicle; and a processor configured to receive predetermined information from a follow-up execution vehicle that performs follow-up travel via the communication unit, select a preceding vehicle suitable as a follow-up target of the follow-up execution vehicle from among the follow-up permitted vehicles based on the predetermined information, and transmit information about the preceding vehicle to the follow-up execution vehicle via the communication unit.

### CROSS-REFERENCE TO RELATED APPLICATION

The present application claims priority to Japanese Patent Application No. 2022-085463 filed on May 25, 2022, which is incorporated herein by reference in its entirety.

### FIELD

The present disclosure relates to a follow-up travel support device and a follow-up travel support method.

### BACKGROUND

PTL 1 discloses that, in a case where a preceding vehicle exists in front of the host vehicle, follow-up travel control is performed so as to follow the preceding vehicle so as to maintain a set inter-vehicle distance.

### CITATIONS LIST

### Patent Literature

[PTL 1] Japanese Unexamined Patent Publication No. 2004-034917

### SUMMARY

### Technical Problem

In the follow-up travel, the air resistance acting on the vehicle traveling behind the preceding vehicle is reduced by the windshield effect of the preceding vehicle, and the fuel consumption or the power consumption in the rear vehicle is reduced. However, the preceding vehicle to be followed cannot enjoy such an effect. In addition, there is a possibility that the driver of the preceding vehicle may feel uncomfortable to be followed by another vehicle.

Therefore, in view of the above problems, an object of the present disclosure is to prevent the follow-up travel to be performed on a vehicle that does not desire to be a follow-up target of another vehicle.

### Solution to Problem

The summary of the present disclosure is as follows.

(1) A follow-up travel support device comprising: a communication unit capable of communicating with a plurality of vehicles; a storage unit storing a list of follow-up permitted vehicles permitting being a follow-up target of another vehicle; and a processor configured to: receive predetermined information from a follow-up execution vehicle that performs follow-up travel via the communication unit; select a preceding vehicle suitable as a follow-up target of the follow-up execution vehicle from among the follow-up permitted vehicles based on the predetermined information; and transmit information about the preceding vehicle to the follow-up execution vehicle via the communication unit.

(2) The follow-up travel support device described in above (1), wherein the processor is configured to receive, as the predetermined information, a surrounding image acquired by the follow-up executing vehicle, perform image recognition of the surrounding image. and select the follow-up permitted vehicle included in the surrounding image as the preceding vehicle.

(3) The follow-up travel support device described in above (1), wherein the processor is configured to receive the position information of the follow-up executing vehicle as the predetermined information.

(4) The follow-up travel support device described in above (1), wherein the processor is configured to receive, as the predetermined information, surrounding vehicle information acquired by the follow-up executing vehicle via inter-vehicle communication.

(5) The follow-up travel support device described in any one of above (1) to (4), wherein the processor is configured to select the preceding vehicle from the follow-up permitted vehicles based on the predetermined information and a travel plan of each of the follow-up permitted vehicles.

(6) The follow-up travel support device described in above (5), wherein the travel plan of each of the follow-up permitted vehicles is a travel route set in advance in each of the follow-up permitted vehicles.

(7) The follow-up travel support device described in above (5), wherein the processor is configured to estimate the travel plan of each of the follow-up permitted vehicles based on a travel history of each of the follow-up permitted vehicles.

(8) The follow-up travel support device described in any one of above (1) to (4), wherein the information on the preceding vehicle includes information on a license plate of the preceding vehicle.

(9) The follow-up travel support device described in any one of above (1) to (4), wherein the processor is configured to notify the preceding vehicle that it has been selected as a follow-up target via the communication unit.

(10) A follow-up travel support method executed by a computer, comprising: storing a list of follow-up permitted vehicles permitting being a follow-up target of another vehicle; receiving predetermined information from a follow-up execution vehicle that executes follow-up travel; selecting a preceding vehicle suitable as a follow-up target of the follow-up execution vehicle from among the follow-up permitted vehicles based on the predetermined information; and transmitting information about the preceding vehicle to the follow-up execution vehicle.

According to the present disclosure, it is possible to prevent the follow-up travel to be performed on a vehicle that does not desire to be a follow-up target of another vehicle.

### BRIEF DESCRIPTION OF DRAWINGS

FIG. 1 is a schematic configuration diagram of the follow-up travel support system according to the first embodiment of the present disclosure.

FIG. 2 is a diagram schematically illustrating a configuration of a server.

FIG. 3 is a diagram illustrating an exemplary configuration of a vehicle.

FIG. 4 is a functional block-diagram of a processor of a server.

FIG. 5 is an example of a database including a list of follow-up permitted vehicles.

FIG. 6 is a flow chart showing a control routine executed in the vehicle according to the first embodiment.

FIG. 7 is a flow chart showing a control routine executed in the server in the first embodiment.

FIG. 8 is a flow chart showing a control routine executed in the server in the second embodiment.

### DESCRIPTION OF EMBODIMENTS

Hereinafter, embodiments of the present disclosure will be described in detail with reference to the drawings. In the following description, the same reference numerals are given to the same constituent elements.

### First Embodiment

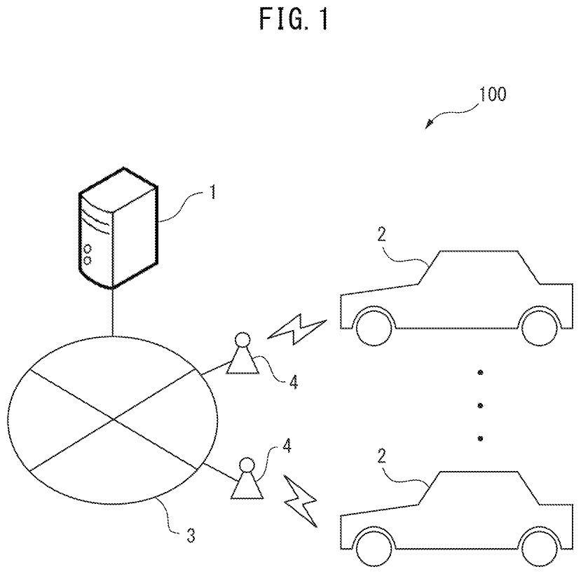

Hereinafter, a first embodiment of the present disclosure will be described referring to FIG. 1 to FIG. 7.

FIG. 1 is a schematic configuration diagram of the follow-up travel support system 10) according to the first embodiment of the present disclosure. As shown in FIG. 1. the follow-up travel support system 100 includes a server 1 and a plurality of vehicles 2. The server 1 is capable of communicating with each of a plurality of vehicles 2 via a communication network 3. such as an Internet network, and a radio base station 4 connected to the communication network 3. The communication between the vehicles 2 and the radio base stations 4 is performed by a known radio communication technique (for example, 3G, LTE, 4G, 5G or the like).

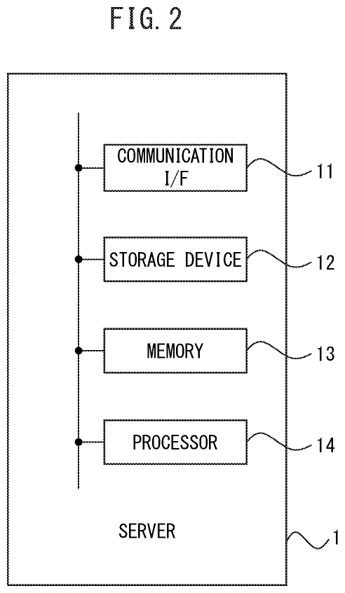

FIG. 2 is a diagram schematically illustrating a configuration of the server 1. As shown in FIG. 2, the server 1 comprises a communication interface 11, a storage device 12, a memory 13 and a processor 14. The communication interface 11, the storage device 12, and the memory 13 are connected to the processor 14 via a signaling line. The server 1 may further include an input device such as a keyboard/mouse, an output device such as a display, and the like. The server 1 may include a plurality of computers.

The communication interface 11 has an interface circuit for connecting the server 1 to the communication network 3. The server 1 communicates with the outside of the server 1 (for example, a plurality of vehicles 2) via the communication interface 11 and the communication network 3. The communication interface 11 is an example of a communication unit of the server 1.

The storage device 12 includes, for example, a hard disk drive (HDD), a solid state drive (SDD), an optical recording medium, and an accessing device thereof. The storage device 12 stores various types of data, and stores, for example, map information, information (identification information, position information, and the like) of the plurality of vehicles 2, and a computer program for the processor 14 to execute various types of processes. The storage device 12 is an example of a storage unit of the server 1.

The memory 13 includes a nonvolatile semiconductor memory (e.g., a RAM). The memory 13 temporarily stores, for example, various kinds of data used when various kinds of processing are executed by the processor 14. The memory 13 is another example of a storage unit of the server 1.

The processor 14 includes one or a plurality of CPU and peripheral circuitry thereof, and executes various processes. The processor 14 may further include other arithmetic circuits such as a logical arithmetic unit, a numerical arithmetic unit, or a graphic processing unit.

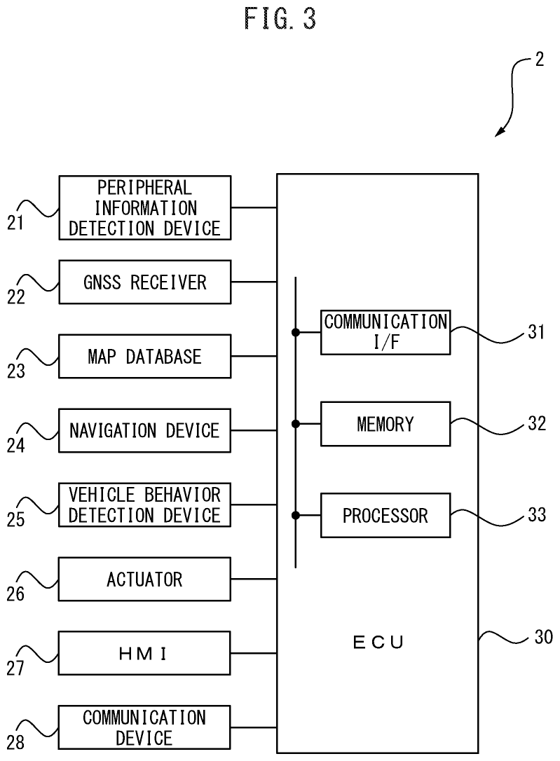

FIG. 3 is a diagram illustrating an exemplary configuration of the vehicle 2. The vehicle 2 comprises a peripheral information detection device 21, a GNSS (Global Navigation Satellite System) receiver 22, a map-database 23, a navigational device 24, a vehicle behavior-detection device 25, an actuator 26, a human-machine interface (HMI) 27, communication device 28 and an electronic control unit (ECU) 30). The peripheral information detection device 21, GNSS receiver 22, the map database 23, the navigation device 24. the vehicle behavior detection device 25, the actuator 26. HM 127 and the communication device 28 are electrically connected to ECU 30 via an in-vehicle network or the like compliant with standards such as CAN (Controller Area Network).

The peripheral information detection device acquires data (images, point cloud data, and the like) around the vehicle 2, and detects surrounding information (for example, a surrounding vehicle, a lane, and the like) of the vehicle 2. For example, the peripheral information detection device 21 includes a camera, a millimeter-wave radar, a LIDAR: Laser Imaging Detection And Ranging, an ultrasonic sensor (sonar), and the like. Output of the peripheral information detection device 21, that is, the peripheral information of the vehicles 2 detected by the peripheral information detection device 21 is transmitted to ECU 30.

The GNSS receiver 22 detects the present position of the vehicle 2 (for example, the latitude and longitude of the vehicle 2) based on positioning information obtained from a plurality of (for example, three or more) positioning satellites. Specifically. GNSS receiver 22 captures a plurality of positioning satellites and receives radio waves transmitted from the positioning satellites. Then, GNSS receiver 22 calculates the distance to the positioning satellite based on the difference between the transmission time and the reception time of the radio wave, and detects the present position of the vehicle 2 based on the distance to the positioning satellite and the position (orbit information) of the positioning satellite. The output of GNSS receiver 22, i.e. the present position of the vehicles 2 detected by GNSS receiver 22, is transmitted to ECU 30. The GPS receiver is an example of the GNSS receiver.

The map database 23 stores map information. The ECU 30 obtains map data from the map database 23. Note that a map database may be provided outside the vehicle 2 (for example, the server 1 or the like), and ECU 30 may acquire map information from outside the vehicle 2.

The navigation device 24 sets the travel route of the vehicle 2 to the destination based on the present position of the vehicle 2 detected by GNSS receiver 22, the map information of the map database 23, the input by the occupant (for example, a driver) of the vehicle 2, and the like. The travel route set by the navigational device 24 is sent to ECU 30.

The vehicle behavior detecting device 25 detects a parameter indicating the behavior of the vehicle 2. The vehicle behavior detecting device 25 includes, for example, a vehicle speed sensor that detects the speed of the vehicle 2, a yaw rate sensor that detects the yaw rate of the vehicle 2, and the like. The output of the vehicle behavior detecting device 25, i.e. the parameters detected by the vehicle behavior detection device 25, is transmitted to ECU 30.

The actuator 26 operates the vehicle. For example, the actuator 26 includes a drive device for acceleration of the vehicle 2 (for example, at least one of an internal combustion engine and an electric motor), a brake actuator for braking the vehicle 2. a steering actuator for steering the vehicle 2, and the like. The ECU 30 controls the actuator 26 to control the behavior of the vehicle 2.

For example, ECU 30 controls the actuator 26 to implement a predetermined driving assistance function. The predetermined driving assistance function includes, for example, an adaptive cruise control (ACC) that automatically controls the velocity of the vehicle according to the presence or absence of the preceding vehicle, a lane keeping assist (LKA) or a lane tracing assist (LTA) that automatically controls the steering of the vehicle so that the vehicle is maintained in the lane, and the like.

The HMI 27 exchanges data between the vehicle 2 and an occupant (for example, a driver) of the vehicle 2. The HMI 27 includes an output unit (for example, a display, a speaker, a vibrating unit, and the like) that provides information to an occupant of the vehicle 2, and an input unit (for example, a touch panel, an operation button, an operation switch, a microphone, and the like) to which information is input by the occupant of the vehicle 2. The output of ECU 30 is notified to the occupant of the vehicle 2 via HMI 27. and the input from the occupant of the vehicle 2 is transmitted to ECU 30 via HMI 27. The HMI 27 is an example of an input device, output device, or input/output device. Note that a mobile terminal (smart phone, tablet terminal, or the like) of the occupant of the vehicle 2 may be connected to ECU 30 so as to be able to communicate with each other by wire or wirelessly, and may function as a HMI 27. The HMI 27 may be integral to the navigational device 24.

The communication device 28 is capable of communicating with the outside of the vehicle 2, and is capable of communicating between the vehicle 2 and the outside of the vehicle 2 (e.g., the server 1). For example, the communication device 28 includes a wide area radio communication device (e.g., a data communication module (DCM)) that enables wide area communication between the vehicle 2 and the outside of the vehicle 2, and an inter-vehicle communication device that enables inter-vehicle communication between the vehicle 2 and the surrounding vehicle using a predetermined frequency band.

The ECU 30 performs various controls of the vehicles. As shown in FIG. 2, ECU 30 comprises a communication interface 31, a memory 32 and a processor 33. The communication interface 31 and the memory 32 are connected to the processor 33 via a signal line. In the present embodiment. one ECU 30 is provided, but a plurality of ECUs may be provided for each function.

The communication interface 31 has interface circuitry for connecting ECU 30 to the in-vehicle networking. The ECU 30 is connected to other in-vehicle devices via the communication interface 31.

The memory 32 includes, for example, a volatile semiconductor memory and a nonvolatile semiconductor memory. The memory 32 stores programs, data, and the like used when various kinds of processing are executed by the processor 33.

The processor 33 comprises one or more CPU(Central Processing Unit) and its peripheral circuitry. The processor 33 may further include an arithmetic circuit such as a logical arithmetic unit or a numerical arithmetic unit.

The configuration shown in FIG. 3 is merely an exemplary configuration of the vehicle 2. The plurality of vehicles 2 may have different configurations as long as they can communicate with the server 1.

In order to reduce the amount of fuel or electric power required for the vehicle to travel, it is effective to reduce the air resistance during the travel. As a method for reducing the air resistance during traveling, follow-up travel in which the vehicle is made to follow the preceding vehicle is exemplified. Platooning in which a plurality of vehicles travel in a platoon is an example of the follow-up travel.

In the follow-up travel, the air resistance acting on the vehicle traveling behind the preceding vehicle is reduced by the windshield effect of the preceding vehicle. However, the preceding vehicle to be followed cannot enjoy such an effect. In addition, there is a possibility that the driver of the preceding vehicle may feel uncomfortable to be followed by another vehicle.

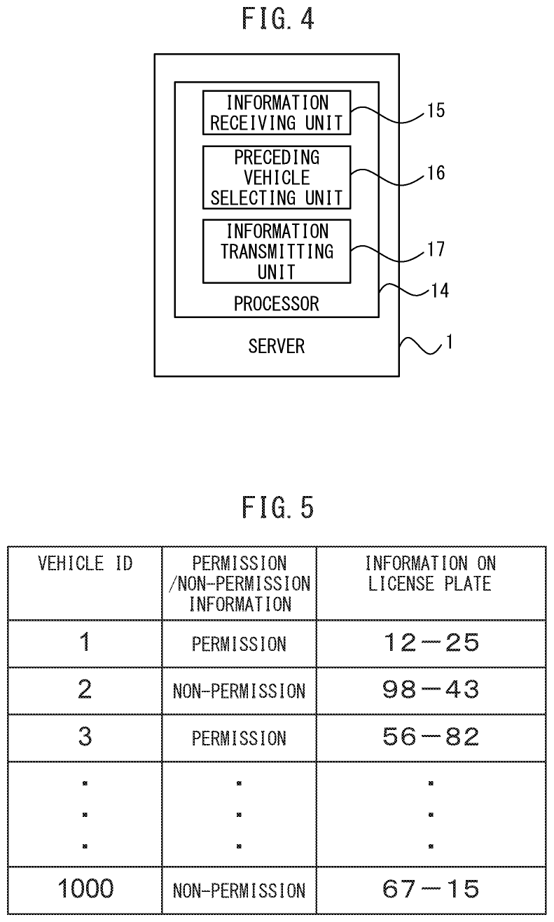

Therefore, in the present embodiment, the server 1 functions as the follow-up travel support device that supports the follow-up travel of the vehicle 2, and selects the preceding vehicle in the follow-up travel. FIG. 4 is a functional diagram of the processor 14 of the server 1. In the present embodiment, the processor 14 includes an information receiving unit 15, a preceding vehicle selection unit 16, and an information transmitting unit 17. The information receiving unit 15, the preceding vehicle selecting unit 16, and the information transmitting unit 17 are functional modules realized by the processor 14 of the server 1 executing a computer program stored in the storage device 12 of the server 1. Note that these functional modules may be realized by a dedicated arithmetic circuit provided in the processor 14.

In order to avoid unnecessary troubles caused by the follow-up travel, it is desirable to know in advance whether or not the candidate vehicle to be followed permits to be followed by another vehicle. Therefore, in the present embodiment, the storage device 12 of the server 1 stores a list of the follow-up permitted vehicles permitting being a follow-up target of another vehicle. This list is created based on prior declaration by the owner or the like of the vehicle 2. For example, the owner of the vehicle 2 uses HMI 27 of the vehicle 2 or the mobile terminal to input, on an application or website for information input, whether or not the own vehicle permits being a follow-up target of another vehicle, and this input information is registered in the storage device 12 of the server 1 as a list together with the identification information (for example, the vehicle ID) of the vehicle 2. The result of the prior declaration by the owner of the vehicle 2 may be input to the server 1 by the operator of the server 1. In addition, an incentive may be given to the owner of the vehicle 2 who has made the advance declaration.

FIG. 5 is an example of a database including a list of follow-up permitted vehicles. The data base shown in FIG. 5 includes, for each of the plurality of vehicles 2, a vehicle ID, information (permission/non-permission information) indicating whether or not to permit the vehicle to be a follow-up target of another vehicle, and information on a license plate. In FIG. 5 example, the information of the vehicle that does not permit to be a follow-up target of another vehicle is also registered, but the column of the permission/non-permission information may be deleted and only the information of the follow-up permitted vehicles may be registered. Further, character information other than numbers may also be registered as the information of the license plate.

The processor 14 of the server 1 selects the preceding vehicle by using the list of follow-up permitted vehicles as follows. First, the information receiving unit 15 receives predetermined information from the follow-up execution vehicle that executes the follow-up travel via the communication interface 11. Then, the preceding vehicle selection unit 16 selects a preceding vehicle suitable as a follow-up target of the follow-up execution vehicle from among the follow-up permitted vehicles based on the predetermined information. Furthermore, the information transmitting unit 17 transmits information on the preceding vehicle to the follow-up execution vehicle via the communication interface 11. As described above, by proposing the preceding vehicle selected from the previously registered follow-up permitted vehicles to the follow-up execution vehicle, it is possible to prevent the follow-up travel to be performed on the vehicle that is not desired to be the follow-up target of another vehicle.

The preceding vehicle needs to be selected from vehicles located in the vicinity of the follow-up execution vehicle. For this reason, for example, the information receiving unit 15 receives, as predetermined information, the surrounding image acquired by the follow-up execution vehicle. Accordingly, it is possible to easily match the vehicle around the follow-up execution vehicle and the follow-up permitted vehicles. In this case, the preceding vehicle selection unit 16 performs image recognition of the surrounding image, and selects the follow-up permitted vehicle included in the surrounding image as the preceding vehicle.

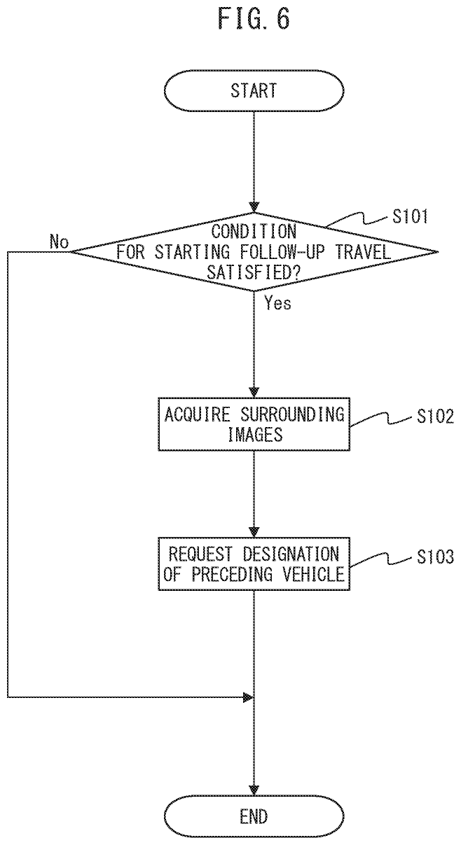

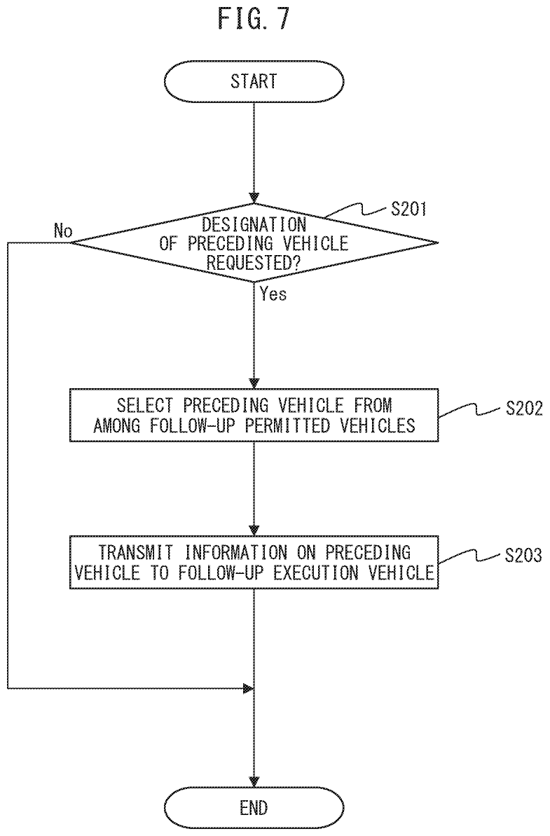

Referring to FIG. 6 and FIG. 7, the process flow of the above-described control will be described in detail. FIG. 6 is a flow chart showing a control routine executed in the vehicle 2 in the first embodiment. The control routine is repeatedly executed by the processor 33 of ECU 30 in each of the plurality of vehicles 2 capable of communicating with the server 1 at predetermined execution intervals.

First, in the step S101, the processor 33 determines whether or not the condition for starting the follow-up travel is satisfied. The condition for starting the follow-up travel is determined in advance, and is satisfied, for example, when the occupant of the vehicle 2 requests the operation of ACC via HMI 27. The start condition of the follow-up travel may be that the vehicle 2 is traveling on an automobile dedicated road at a speed equal to or higher than a predetermined value. or the like. If it is determined in the step S101 that the condition for starting the follow-up travel is not satisfied, the present control routine ends.

On the other hand, if it is determined in the step S101 that the condition for starting the follow-up travel is satisfied, the present control routine proceeds to step S102. In the step S102, the processor 33 acquires the surrounding images using the camera of the peripheral information detecting device 21.

Next, in the step S103, the processor 33 requests the server 1 to designate the preceding vehicle in the follow-up travel. For example, the processor 33 transmits a request signal requesting the designation of the preceding vehicle to the server 1 together with the surrounding image. After the step S103, the control routine ends.

FIG. 7 is a flow chart showing a control routine executed in the server 1 in the first embodiment. This control routine is repeatedly executed by the processor 14 of the server 1 at predetermined execution intervals.

First, in the step S201, the preceding vehicle selection unit 16 determines whether the designation of the preceding vehicle is requested from the vehicle 2. When the request signal is not transmitted from the vehicle 2 to the server 1, it is determined that designation of the preceding vehicle is not requested from the vehicle 2, and the present control routine ends. On the other hand, when a request signal is transmitted from the vehicle 2 to the server 1, it is determined that the designation of the preceding vehicle is requested from the vehicle 2, and the control routine proceeds to step S202. In this case, the preceding vehicle selection unit 16 recognizes the vehicle 2 that has requested the designation of the preceding vehicle as the follow-up execution vehicle.

In the step S202, the preceding vehicle selection unit 16 executes a preceding vehicle from among the follow-up permitted vehicles stored as a list in the storage device 12 based on the surrounding images transmitted from the follow-up execution vehicle. Specifically, the preceding vehicle selection unit 16 performs image recognition of the surrounding image acquired by the follow-up execution vehicle, and selects the follow-up permitted vehicle included in the surrounding image as the preceding vehicle. For example, the preceding vehicle selection unit 16 detects information on the vehicle traveling in the same direction as the follow-up execution vehicle (for example, information on the license plate) from the surrounding image by the image recognition technology, and extracts the follow-up permitted vehicle by matching this information to the information on the follow-up permitted vehicle. Such an image recognition technique is, for example, a machine learning model such as a neural network. a support vector machine, or a random forest.

Next, in the step S203, the information transmitting unit 17 transmits information on the preceding vehicle selected by the preceding vehicle selecting unit 16 to the follow-up execution vehicle. Consequently, in the follow-up execution vehicle, the driver of the follow-up execution vehicle is notified of the information regarding the preceding vehicle via the HMI 27. The information on the preceding vehicle includes, for example, information on a license plate of the preceding vehicle (for example, a number of the license plate). By notifying the driver of the follow-up execution vehicle of the information on the license plate of the preceding vehicle, it is possible to facilitate the discovery of the preceding vehicle by the driver of the follow-up execution vehicle.

Note that the current position of the vehicle 2 may be periodically transmitted from the vehicle 2 to the server 1, and the information regarding the preceding vehicle may include position information of the preceding vehicle (such as a relative position of the preceding vehicle with respect to the follow-up execution vehicle). In addition, the appearance information (vehicle type, color, and the like) of the follow-up permitted vehicle may be stored in advance in a database, and the information on the preceding vehicle may include the appearance information of the preceding vehicle. After the step S203, the control routine ends.

Note that the information receiving unit 15 may receive, as predetermined information, the surrounding vehicle information acquired by the follow-up execution vehicle via the inter-vehicle communication, and the preceding vehicle selection unit 16 may extract the follow-up permitted vehicle around the follow-up execution vehicle based on the surrounding vehicle information. In this way, a vehicle that cannot be detected by the camera can also be recognized as a follow-up permitted vehicle. In this case, the processor 33 of ECU 30 acquires the surrounding vehicle information (for example, the information of the vehicle ID or the license plate of the surrounding vehicle traveling in the same direction as the vehicle 2) by communicating with the surrounding vehicle of the vehicle 2 using the inter-vehicle communicator of the communication device 28 in FIG. 6 step S102, and transmits the surrounding vehicle information to the server 1 together with the request signal in FIG. 6 step S103. On the other hand, in the step S202 of FIG. 7, the preceding vehicle selection unit 16 of the server 1 compares the surrounding vehicle information with the information of the follow-up permitted vehicle, and selects the follow-up permitted vehicle included in the surrounding vehicle as the preceding vehicle.

Further, the information receiving unit 15 may receive the position information of the follow-up execution vehicle as predetermined information, and the preceding vehicle selecting unit 16 may extract the follow-up permitted vehicle around the follow-up execution vehicle based on the position information of the follow-up execution vehicle. Thus, even when the follow-up execution vehicle does not include the camera and the inter-vehicle communication device, it is possible to extract the follow-up permitted vehicle around the follow-up execution vehicle. In this instance, the processor 33 of ECU 30 acquires the current position of the vehicle 2 using GNSS receiver 22 in the step S102 of FIG. 6, and transmits the position information (for example, the current position and the traveling direction) of the vehicle 2 to the server 1 together with the request signal in the step S103 of FIG. 6. On the other hand, in the step S202 of FIG. 7, the preceding vehicle selection unit 16 of the server 1 matches the position information of the follow-up execution vehicle to the position information of the follow-up permit vehicle, and selects the follow-up permission vehicle that is located in the vicinity of the follow-up execution vehicle and travels in the same direction as the follow-up execution vehicle as the preceding vehicle.

Further, in addition to transmitting the information on the preceding vehicle to the follow-up execution vehicle, the information transmitting unit 17 may notify the preceding vehicle that it has been selected as the follow-up target via the communication interface 11. Accordingly, the driver of the follow-up permitted vehicle selected as the preceding vehicle can be made aware of the presence of the follow-up execution vehicle, and the follow-up travel to the preceding vehicle by the follow-up execution vehicle can be started more smoothly.

### Second Embodiment

The configuration and control of the follow-up travel support device according to the second embodiment are basically the same as the configuration and control of the follow-up travel support device according to the first embodiment except for the points described below. Therefore, the second embodiment of the present disclosure will be mainly described below with respect to portions different from the first embodiment.

In a case where a plurality of follow-up permitted vehicles exist in the vicinity of the follow-up execution vehicle, it is conceivable to select the follow-up permitted vehicle in front of the follow-up execution vehicle or the follow-up permitted vehicle closest to the follow-up execution vehicle as the preceding vehicle. However, the follow-up permitted vehicle is not always optimal as a follow-up target. For example, in a case where the overlapping travel section between the follow-up execution vehicle and the follow-up permitted vehicle is short, the execution time of the follow-up travel is shortened, and the effect of the follow-up travel is reduced.

Therefore, in the second embodiment, the preceding vehicle selection unit 16 selects the preceding vehicle from the follow-up permitted vehicles on the basis of the predetermined information (for example, a surrounding image) transmitted from the follow-up execution vehicle and the travel plan of each of the following permitted vehicles. For example, the preceding vehicle selection unit 16 extracts the preceding vehicle candidates from the follow-up permitted vehicles based on the predetermined information, and selects the preceding vehicle from the preceding vehicle candidates based on the travel plan of each of the follow-up permitted vehicles extracted as the preceding vehicle candidates. In this way, it is possible to propose a preceding vehicle capable of further enhancing the effect of the follow-up travel to the follow-up execution vehicle.

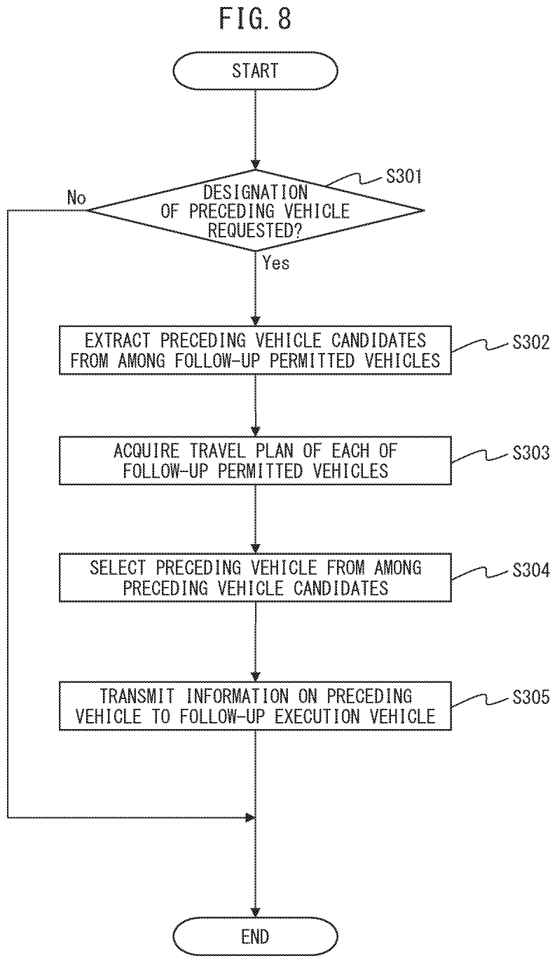

In the second embodiment, the control routine of FIG. 6 is executed in the vehicle 2 as in the first embodiment, and the control routine of FIG. 8 is executed in the server 1 instead of the control routine of FIG. 7. FIG. 8 is a flow chart showing a control routine executed in the server 1 in the second embodiment. This control routine is repeatedly executed by the processor 14 of the server 1 at predetermined execution intervals.

First, in step S301, similarly to the step S201 of FIG. 7, the preceding vehicle selection unit 16 determines whether or not designation of the preceding vehicle is requested from the vehicle 2. When the request signal is not transmitted from the vehicle 2 to the server 1, it is determined that designation of the preceding vehicle is not requested from the vehicle 2, and the present control routine ends. On the other hand, when a request signal is transmitted from the vehicle 2 to the server 1, it is determined that the designation of the preceding vehicle is requested from the vehicle 2, and the control routine proceeds to step S302. In this case, the preceding vehicle selection unit 16 recognizes the vehicle 2 that has requested the designation of the preceding vehicle as the follow-up execution vehicle.

In the step S302, the preceding vehicle selection unit 16 extracts the preceding vehicle candidates from the follow-up permitted vehicles stored as a list in the storage device 12 on the basis of the surrounding images transmitted from the follow-up execution vehicle. Specifically, the preceding vehicle selection unit 16 performs image recognition of the surrounding image acquired by the follow-up execution vehicle, and extracts the follow-up permitted vehicles included in the surrounding image as the preceding vehicle candidates. For example, the preceding vehicle selection unit 16 detects information on the vehicle traveling in the same direction as the follow-up execution vehicle (for example, information on the license plate) from the surrounding image by the image recognition technology, and extracts the follow-up permitted vehicles by matching this information to the information on the follow-up permitted vehicles. Such an image recognition technique is, for example, a machine learning model such as a neural network, a support vector machine, or a random forest.

Next, in the step S303, the preceding vehicle selection unit 16 acquires the travel plan of each of the follow-up permitted vehicles extracted as the preceding vehicle candidates. For example, the preceding vehicle selection unit 16 requests the follow-up permitted vehicles to transmit the travel route, and receives the travel route set in advance in the follow-up permitted vehicle via the navigation device 24 or the like from the follow-up permitted vehicle.

Next, in the step S304, the preceding vehicle selection unit 16 selects the preceding vehicle from among the preceding vehicle candidates based on the travel plan of each of the follow-up permitted vehicles. For example, the preceding vehicle selection unit 16 selects the follow-up permitted vehicle having the longest estimated follow-up possible distance as the preceding vehicle. The estimated follow-up possible distance is calculated as, for example, a distance from the current position of the follow-up permitted vehicle to a point where the follow-up permitted vehicle exits the automobile dedicated road.

Next, in the step S305, the preceding vehicle selection unit 16 transmits the information about the preceding vehicle selected by the preceding vehicle selection unit 16 to the follow-up execution vehicle as in the step S203 of FIG. 7. After the step S305, the control routine ends.

As in the first embodiment, the information receiving unit 15 may receive, as the predetermined information, the position information of the follow-up execution vehicle or the surrounding vehicle information acquired by the follow-up execution vehicle via the inter-vehicle communication from the follow-up execution vehicle. That is, the predetermined information used for extracting the preceding vehicle candidates in the step S302 may be the position information of the follow-up execution vehicle or the surrounding vehicle information acquired by the follow-up execution vehicle via the inter-vehicle communication.

Further, in the step S303, in addition to the travel route, the preceding vehicle selection unit 16 may receive, from the follow-up permitted vehicle, information on a rest point (for example, a service area (SA) or a parking area (PA)) on the travel route previously inputted by the driver of the follow-up permitted vehicle via HMI 27. In this case, if the rest point is set on the travel route of the follow-up permitted vehicle, the estimated follow-up possible distance is calculated as the distance from the current position of the follow-up permitted vehicle to the rest point. Further, the travel route of the follow-up execution vehicle may be transmitted from the follow-up execution vehicle to the server 1, and the estimated follow-up possible distance may be calculated as an overlap section between the travel route of the follow-up execution vehicle and the travel route of the follow-up permitted vehicle.

Further, instead of acquiring the travel route from the follow-up permitted vehicle, the preceding vehicle selection unit 16 may estimate the travel plan of the follow-up permitted vehicle based on the travel history of the follow-up permitted vehicle. Thus, even when the travel route is not set in the follow-up permitted vehicle, the preceding vehicle can be selected in consideration of the travel plan of the follow-up permitted vehicle. In this case, the travel history of the follow-up permitted vehicle is stored in the storage device 12 of the server 1, and, for example, a travel route in which the most number of the follow-up permitted vehicles have traveled from the present position in the past is adopted as the travel plan of the follow-up permitted vehicle.

### OTHER EMBODIMENTS

While preferred embodiments of the present disclosure have been described above, the present disclosure is not limited to these embodiments, and various modifications and changes can be made within the scope of the claims. For example, the preceding vehicle selection unit 16 may select a plurality of follow-up permitted vehicles as the preceding vehicle.

The follow-up execution vehicle may be a manual driving vehicle that does not have a driving assistance function. Further, the follow-up execution vehicle may be a fully automated driving vehicle in which all of acceleration, steering, and deceleration (braking) of the vehicle are automatically executed. In this case, when the information about the preceding vehicle is transmitted to the follow-up execution vehicle, the ECU of the follow-up execution vehicle controls the actuator to automatically start the follow-up travel to the preceding vehicle.

### DESCRIPTION OF SYMBOLS

1 Server
11 Communication Interface
12 Storage device
13 Memory
14 Processor
15 Information receiving unit
16 Preceding vehicle selection unit
17 Information transmitting unit
2 Vehicle

1. A follow-up travel support device comprising:
a communication unit capable of communicating with a plurality of vehicles;
a storage unit storing a list of follow-up permitted vehicles permitting being a follow-up target of another vehicle; and
a processor configured to:
receive predetermined information from a follow-up execution vehicle that performs follow-up travel via the communication unit;
select a preceding vehicle suitable as a follow-up target of the follow-up execution vehicle from among the follow-up permitted vehicles based on the predetermined information; and
transmit information about the preceding vehicle to the follow-up execution vehicle via the communication unit.

2. The follow-up travel support device according to claim 1, wherein the processor is configured to receive, as the predetermined information, a surrounding image acquired by the follow-up executing vehicle, perform image recognition of the surrounding image, and select the follow-up permitted vehicle included in the surrounding image as the preceding vehicle.

3. The follow-up travel support device according to claim 1, wherein the processor is configured to receive the position information of the follow-up executing vehicle as the predetermined information.

4. The follow-up travel support device according to claim 1, wherein the processor is configured to receive, as the predetermined information, surrounding vehicle information acquired by the follow-up executing vehicle via inter-vehicle communication.

5. The follow-up travel support device according to claim 1, wherein the processor is configured to select the preceding vehicle from the follow-up permitted vehicles based on the predetermined information and a travel plan of each of the follow-up permitted vehicles.

6. The follow-up travel support device according to claim 5, wherein the travel plan of each of the follow-up permitted vehicles is a travel route set in advance in each of the follow-up permitted vehicles.

7. The follow-up travel support device according to claim 5, wherein the processor is configured to estimate the travel plan of each of the follow-up permitted vehicles based on a travel history of each of the follow-up permitted vehicles.

8. The follow-up travel support device according to claim 1, wherein the information on the preceding vehicle includes information on a license plate of the preceding vehicle.

9. The follow-up travel support device according to claim 1, wherein the processor is configured to notify the preceding vehicle that it has been selected as a follow-up target via the communication unit.

10. A follow-up travel support method executed by a computer, comprising:
storing a list of follow-up permitted vehicles permitting being a follow-up target of another vehicle;
receiving predetermined information from a follow-up execution vehicle that executes follow-up travel:
selecting a preceding vehicle suitable as a follow-up target of the follow-up execution vehicle from among the follow-up permitted vehicles based on the predetermined information; and
transmitting information about the preceding vehicle to the follow-up execution vehicle.
